(19) United States
(12) Patent Application Publication
(10) Pub. No.: US 2020/0070578 A1
(43) Pub. Date: Mar. 5, 2020

(54) RUBBER COMPOSITION, VULCANIZED RUBBER, TIRE, STUDLESS TIRE

(71) Applicant: Bridgestone Corporation, Tokyo (JP)

(72) Inventor: Masahiro KAWASHIMA, Chuo-ku (JP)

(73) Assignee: Bridgestone Corporation, Tokyo (JP)

(21) Appl. No.: 16/675,409

(22) Filed: Nov. 6, 2019

Related U.S. Application Data
(63) Continuation of application No. PCT/JP2018/011154, filed on Mar. 20, 2018.

(30) Foreign Application Priority Data
May 10, 2017 (JP) 2017-094134

(51) Int. Cl. B60C 1/00; C08K 7/02; C08K 5/00; C08J 9/00; C08J 9/06

(52) U.S. Cl. CPC B60C 1/0016; C08K 7/02; C08K 5/0025; C08J 9/0085; C08J 9/009; C08J 2477/00; C08K 2201/004; C08K 2201/005; C08K 2201/006; C08J 2309/00; C08J 2433/04; C08J 9/06

(57) ABSTRACT

The rubber composition of the present invention contains a rubber component and a short fibrous resin D1 having a ratio A/B of larger than 1, wherein A is a length of a cross section perpendicular to a long axis direction in a long diameter direction thereof and B is a length of the cross section perpendicular to the long axis direction in a short diameter direction thereof. A vulcanized rubber having a large water absorbing force can be obtained from the rubber composition. In addition, the present invention provides a vulcanized rubber having a water absorbing force, a tire having excellent on-ice performance, and a studless having excellent on-ice performance.

### TECHNICAL FIELD

The present invention relates to a rubber composition, a vulcanized rubber, a tire, and a studless tire.

### BACKGROUND ART

From the viewpoint of improving the safety of vehicles, there have hitherto been made various investigations in order to improve braking performance, driving performance, and so on of a tire on not only dry road surfaces but also various road surfaces, such as wet road surfaces and icy and snowy road surfaces. For example, in order to improve on-ice performance, a winter tire, such as a studless tire, is provided with a foamed rubber layer in a tire tread section.

More specifically, for example, as compared with the conventional technology, in order to provide a pneumatic tire further increasing a water removing effect and sharply improving on-ice performance, it is disclosed that a pneumatic tire provided with a foamed rubber layer on the face of a tire tread at least practically kept in contact with the road surface is configured such that the foamed rubber layer has closed cells having an average diameter of 40 to 50 μm and a foaming ratio of 10 to 25% and contains 1 to 15 parts by weight of short fibers based on 100 parts by weight of the rubber component; and that the short fibers have a length of 0.5 to 5.0 mm and an average diameter of 40 to 50 μm and have a heat shrinkage ratio at 170° C. of 8% or less (see, for example, PTL 1).

### CITATION LIST

### Patent Literature

PTL 1: JP-A 10-24704

### SUMMARY OF INVENTION

### Technical Problem

However, the cells formed through foaming involved such a problem that the water removing effect is not sufficient.

An object of the present invention is to provide a rubber composition from which a vulcanized rubber having a large water absorbing force can be obtained, a vulcanized rubber having a large water absorbing force, a tire which is excellent in on-ice performance, and a studless which is excellent in on-ice performance, and a problem of the present invention is to solve the foregoing object.

### Solution to Problem

<1> A rubber composition containing a rubber component and a short fibrous resin having a ratio A/B of larger than 1, wherein A is a length of a cross section perpendicular to a long axis direction in a long diameter direction thereof and B is a length of the cross section perpendicular to the long axis direction in a short diameter direction thereof.
<2> The rubber composition as set forth in <1>, further containing a foaming agent.
<3> The rubber composition as set forth in <1> or <2>, wherein the short fibrous resin is a complex resin comprising a hydrophilic resin and a coat layer coating the hydrophilic resin, wherein the coat layer is composed of a resin having an affinity with the rubber component.
<4> The rubber composition as set forth in <3>, wherein the hydrophilic resin contains at least one selected from an oxygen atom, a nitrogen atom, and a sulfur atom.
<5> The rubber composition as set forth in <3> or <4>, wherein the resin having an affinity with the rubber component is a low-melting point resin having a melting point lower than a maximum vulcanization temperature of the rubber composition.
<6> The rubber composition as set forth in any one of <1> to <5>, wherein the ratio A/B of the short fibrous resin is 10 or less.
<7> The rubber composition as set forth in any one of <1> to <6>, wherein an average length of the short fibrous resin in a longitudinal direction is from 0.1 to 500 mm.
<8> The rubber composition as set forth in any one of <1> to <7>, wherein the content of the short fibrous resin is from 0.1 to 100 parts by mass based on 100 parts by mass of the rubber component.
<9> The rubber composition as set forth in any one of <1> to <8>, wherein an average area of the cross section of the short fibrous resin is from 0.000001 to 0.5 mm².
<10> The rubber composition as set forth in any one of <3> to <9>, wherein the hydrophilic resin contains at least one substituent selected from the group consisting of —OH, —COOH, —OCOR (where R is an alkyl group), —NH₂, —NCO, and —SH.
<11> The rubber composition as set forth in any one of <3> to <10>, wherein the hydrophilic resin contains at least one selected from the group consisting of an ethylene-vinyl alcohol copolymer, a vinyl alcohol homopolymer, a poly(meth)acrylic acid resin, a polyamide resin, an aliphatic polyamide-based resin, an aromatic polyamide-based resin, a polyester resin, a polyolefin resin, a polyvinyl alcohol-based resin, and an acrylic resin.
<12> The rubber composition as set forth in any one of <5> to <11>, wherein the low-melting point resin is a polyolefin-based resin.
<13> The rubber composition as set forth in <12>, wherein the polyolefin-based resin contains at least one selected from the group consisting of a polyethylene-based resin, a polypropylene-based resin, a polyolefin ionomer, and a maleic anhydride-modified α-polyolefin.
<14> The rubber composition as set forth in any one of <1> to <13>, which is a rubber composition for tread.
<15> A vulcanized rubber obtained by vulcanizing the rubber composition as set forth in any one of <1> to <14>.
<16> The vulcanized rubber as set forth in <15>, having a flat void having a ratio M/N of larger than 1, wherein M is a length of a cross section perpendicular to a long axis direction in a long diameter direction thereof and N is a length of the cross section perpendicular to the long axis direction in a short diameter direction thereof, with a proportion of the flat void being half the number or more of all voids.
<17> The vulcanized rubber as set forth in <15> or <16>, wherein at least a part of a wall face of the void is hydrophilized.
<18> A tire including the vulcanized rubber as set forth in any one of <15> to <17>.
<19> A studless tire including the vulcanized rubber as set forth in any one of <15> to <17>.

### Advantageous Effects of Invention

In accordance with the present invention, a rubber composition from which a vulcanized rubber having a large water absorbing force can be obtained, a vulcanized rubber having a large water absorbing force, a tire which is excellent in on-ice performance, and a studless which is excellent in on-ice performance can be provided.

### BRIEF DESCRIPTION OF DRAWINGS

FIG. 1 is a schematic view illustrating a short fibrous resin to be contained in a rubber composition of the present invention.

FIG. 2 is a schematic view illustrating shapes of a short fibrous resin to be contained in a rubber composition of the present invention and a conventional short fibrous resin, and a cross-sectional shape of a void originated from each of these resins.

FIG. 3 is a longitudinal cross-sectional view of a die to be installed in a twin-screw extruder.

FIG. 4 is a longitudinal cross-sectional view of a die to be installed in a twin-screw extruder.

FIG. 5 is a schematic view illustrating a cross-sectional shape of a void originated from a short fibrous resin.

FIG. 6 is a schematic view illustrating a cross-sectional shape of an irregular void originated from a complexed short fibrous resin.

### DESCRIPTION OF EMBODIMENTS

### <Rubber Composition>

The rubber composition of the present invention contains a rubber component and a short fibrous resin having a ratio A/B of larger than 1, wherein A is a length of a cross section perpendicular to a long axis direction in a long diameter direction thereof and B is a length of the cross section perpendicular to the long axis direction in a short diameter direction thereof.

The rubber composition of the present invention is an unvulcanized rubber composition before vulcanization, and the vulcanized rubber is obtained by vulcanizing the rubber composition of the present invention.

The “short fibrous resin having a ratio A/B of larger than 1, wherein A is a length of a cross section perpendicular to a long axis direction in a long diameter direction thereof and B is a length of the cross section perpendicular to the long axis direction in a short diameter direction thereof” is occasionally referred to as “flat resin”.

In the case where the rubber composition contains the rubber component and the flat resin, the vulcanized rubber obtained by vulcanizing the rubber composition becomes large in terms of a water absorbing force.

First of all, geometrical features of the flat resin and reasons why when the rubber composition of the present invention contains the flat resin, the water absorbing force of the vulcanized rubber becomes large are described.

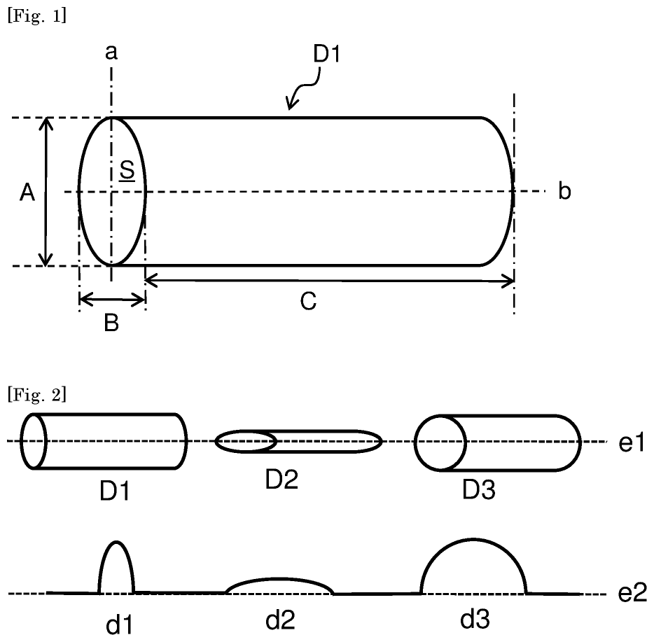

FIG. 1 is a schematic view illustrating an example of the short fibrous resin to be contained in the rubber composition of the present invention.

FIG. 1 illustrates a resin D1 (flat resin) in an elliptic cylindrical form. The resin D1 has a cross section S perpendicular to a long axis direction b, and a distance of a long diameter direction a having a longest diameter in the cross section S is referred to as a length A. In addition, in the cross section S, a distance of the cross section S in a short diameter direction perpendicular to the long diameter direction a is referred to as a length B.

In the case where the length A of the long diameter of the cross section S to the length B of the short diameter of the cross section S, namely A/B, is larger than 1, the cross section S becomes elliptical. Although FIG. 1 illustrates one whose cross-sectional shape is elliptical, so far as A/B is larger than 1, the cross-sectional shape is not particularly limited and may be any of elliptical, rectangular, polygonal, and irregular shapes.

With respect to resins conventionally used as a short fiber, an aspect ratio of the resin itself, namely, with respect to the resin D1, a ratio C/A of a length C in the long axis direction b (length of the short fibrous resin in the longitudinal direction) to the length A of the long diameter of the cross section S, has been studied. However, in the present invention, attention is paid to the ratio A/B of the length A of the long diameter to the length B of the short diameter in the cross section S.

Details of a preparation method of the rubber composition are mentioned later. However, when the rubber component and the flat resin are kneaded, the flat resin in the rubber composition is randomly oriented, and the long axis direction b of the short fibrous resin D1 is oriented perpendicular to the surface of the vulcanized rubber, or the long axis direction b of the short fibrous resin D1 is oriented parallel to the surface of the vulcanized rubber.

In view of the fact that the short fibrous resin D1 has a flat shape, even in the case where the long axis direction b of the short fibrous resin D1 is oriented parallel to the surface of the vulcanized rubber, it may be considered that the long diameter direction a of the cross sectional S is oriented perpendicular to the surface of the vulcanized rubber, or oriented parallel to the surface of the vulcanized rubber.

Such an oriented state of the short fibrous resin D1 can be confirmed through observation of the cut surface obtained by cutting the vulcanized rubber by using an optical microscope.

In the case where such a short fibrous resin having a flat shape is contained in the rubber composition together with the rubber component, in the vulcanized rubber and the tire obtained by vulcanizing the rubber composition, the flat resin is readily contained, or a void originated from the flat resin is readily generated. For example, by using, as the short fibrous resin, a resin having a melting point lower than the vulcanization temperature of the rubber composition, the short fibrous resin is melted owing to vulcanization of the rubber composition, whereby a void originated from the resin is readily generated in the vulcanized rubber. In addition, when the vulcanized rubber is rubbed by the road surface or the like, the short fibrous resin occasionally peels off from the vulcanized rubber, thereby generating a void.

Now, occurrence of skidding of the tire on the frozen road surface is mainly caused due to generation of a film of water between an ice on the road surface and the tire.

The void generated when the short fibrous resin is melted or peels off becomes a waterway on the tire surface (particularly the tread surface), and the water film on the road surface is taken into the void. As a result, the tire surface comes into intimate contact with the icy road surface, thereby enabling skidding to be suppressed.

In the case where the short fibrous resin is oriented on the surface of the vulcanized rubber such that the long axis direction thereof becomes perpendicular to the surface of the vulcanized rubber, in other words, a pillar is erected on the ground, and a void is generated, even when the cross-sectional shape orthogonal to the long axis direction of the short fibrous resin is either perfectly circular or elliptical, the depth of the void is longer than the size of the width, and therefore, it may be considered that water absorption is readily caused due to a capillary phenomenon.

On the other hand, in the case where the short fibrous resin is oriented on the surface of the vulcanized rubber such that the long axis direction thereof becomes parallel to the surface of the vulcanized rubber, in other words, a pillar lies on the ground, it may be considered that the water absorbing force varies with the cross-sectional shape orthogonal to the long axis direction of the short fibrous resin.

FIG. 2 is a schematic view illustrating shapes of a short fibrous resin to be contained in the rubber composition of the present invention and the conventional short fibrous resin, and the cross-sectional shape of the void originated from each of these short fibrous resins.

FIG. 2 illustrates shapes of short fibrous resins D1, D2, and D3 before being incorporated into the rubber composition, and voids d1, d2, and d3 originated from the short fibrous resins D1, D2, and D3. The voids d1, d2, and d3 are each a void generated on a cut surface e2 of the vulcanized rubber obtained by mixing each of the short fibrous resins D1, D2, and D3 in the rubber composition and vulcanizing the mixture, followed by cutting. All of the short fibrous resins D1, D2, and D3 are those oriented such that a long axis direction e1 of each of the short fibrous resins D1, D2, and D3 is parallel to the cut surface e2 of the vulcanized rubber. In addition, the shapes of the voids d1, d2, and d3 illustrated in FIG. 2 are cross-sectional shapes obtained by cutting the voids originated from the short fibrous resins D1, D2, and D3, respectively in a direction orthogonal to the long axis direction e1.

In FIG. 2, the short fibrous resins D1 and D2 are a short fibrous resin (flat resin) in the present invention, and D3 is a resin of a short fiber contained in the conventional rubber composition.

The resin of the short fiber contained in the conventional rubber composition had a perfectly circular cross-sectional shape, and therefore, in the case where the resin D3 is oriented such that the long axis direction e1 is parallel to the vulcanized rubber surface, the cross-sectional shape of the void did not alter.

In contrast, the short fibrous resin to be used in the present invention has a flat shape, and therefore, the long diameter direction of the cross section is oriented perpendicular to the cut surface e2 of the vulcanized rubber as in the short fibrous resin D1, or oriented parallel to the cut surface e2 of the vulcanized rubber as in the short fibrous resin D2.

In the short fibrous resin in which the long diameter direction of the cross section is oriented perpendicular to the cut surface e2 of the vulcanized rubber as in the short fibrous resin D1, when forming a void, the depth of the void readily becomes long relative to the width of the void. In the void d1, a water absorbing action due to a capillary phenomenon acts, whereby the water absorbing force is improved as compared with that in the conventional void d3.

In the short fibrous resin in which the long diameter direction of the cross section is oriented parallel to the cut surface e2 of the vulcanized rubber as in the short fibrous resin D2, when forming a void, the depth of the void short relative to the width of the void, and it may be considered that the capillary phenomenon as in the void d1 does not act. However, it may be considered that the void 2 functions as a waterway the same as in the conventional void d3.

In the light of the above, in the vulcanized rubber and the tire obtained by vulcanizing the rubber composition of the present invention, a void having a long depth relative to the width of the void as in the void d1 is formed on the vulcanized rubber surface or the tire surface, and therefore, it may be considered that the water absorbing force is larger than that in the conventional vulcanized rubber and tire. Accordingly, in the tire and the studless tire produced using the rubber composition of the present invention, it may be considered that a spring water absorbing force on the ice is improved owing to the capillary phenomenon, whereby the on-ice performance is improved.

The rubber composition, the vulcanized rubber, and the tire of the present invention are hereunder described in detail.

Description will be made while omitting symbols in the drawings unless otherwise indicated.

### [Rubber Component]

The rubber component to be used for the rubber composition of the present invention is not particularly limited, and besides a natural rubber (NR), synthetic rubbers, such as a polyisoprene rubber (IR), a styrene-butadiene copolymer rubber (SBR), a polybutadiene rubber (BR), an ethylene-propylene-diene rubber (EPDM), a chloroprene rubber (CR), a butyl halide rubber, and an acrylonitrile-butadiene rubber (NBR), can be used. Above all, a natural rubber (NR), a styrene-butadiene copolymer rubber (SBR), and a polybutadiene rubber (BR) are preferred. These rubber components may be used alone or may be used in combination of two or more thereof.

### [Short Fibrous Resin]

The rubber composition of the present invention contains a short fibrous resin having a ratio A/B of larger than 1, wherein A is a length of a cross section perpendicular to a long axis direction in a long diameter direction thereof and B is a length of the cross section perpendicular to the long axis direction in a short diameter direction thereof.

In the short fibrous resin (flat resin) in the present invention, so far as A/B is larger than 1, the shape and the area of the cross section perpendicular to the long axis direction (cross section S in FIG. 1) and the length of the long axis direction (length C in FIG. 1) are not particularly limited. From the viewpoint of improving the water absorbing force of the vulcanized rubber, the flat resin is short fibrous.

Specifically, the area of the cross section perpendicular to the long axis direction of the flat resin (section Sin FIG. 1) is preferably 0.000001 to 0.5 mm², and more preferably 0.00002 to 0.2 mm² in terms of an average area from the viewpoint of more improving the water absorbing force of the vulcanized rubber.

Although the shape of the cross section perpendicular to the long axis direction of the flat resin (section S in FIG. 1) may be any of elliptical, triangular, rectangular, polygonal, and irregular shapes, from the viewpoint of improving the water absorbing force of the vulcanized rubber, it is preferably elliptical or rectangular, and more preferably elliptical.

An average length of the length of the flat resin in the long axis direction (length C in FIG. 1) (average length of the short fibrous resin in the longitudinal direction) is preferably 0.1 to 500 mm, and more preferably 0.1 to 7 mm.

When the cross-sectional area and the length in the long axis direction of the flat resin fall within the aforementioned ranges, not only the water absorbing force of the vulcanized rubber is improved, but also the short fibrous resins are hardly tangled with each other more than necessary and are readily dispersed favorably within the rubber composition.

The average area of the cross section perpendicular to the long axis direction of the flat resin (section S in FIG. 1) and the average length of the flat resin in the long axis direction (length C in FIG. 1) are each an average value of 100 resins as randomly selected. In addition, the length A, the length B, and the length C of the flat resin can be each measured by observing the resin using an optical microscope of 20 to 400 magnifications.

From the viewpoint of more increasing the water absorbing force of the vulcanized rubber, A/B is preferably 1.5 or larger, and more preferably 2.0 or larger. Although an upper limit of A/B is not particularly limited, in resins of a short fiber having the aforementioned preferred cross-sectional area, it is difficult to produce a resin whose A/B is larger than 10. In consequence, A/B is preferably 10 or lower, and from the viewpoint of more increasing the water absorbing force of the vulcanized rubber, A/B is more preferably 5 or lower.

From the viewpoint of more increasing the water absorbing force of the vulcanized rubber, the length A of the flat resin is preferably 0.001 to 2 mm, and more preferably 0.005 to 0.5 mm in terms of an average value of the 100 resins.

C/A that is a ratio of the length in the long axis direction of the flat resin (length C in FIG. 1) to the length A of the long diameter of the cross section of the flat resin is typically 10 to 4,000, and preferably 50 to 2,000.

From the viewpoint of increasing the water absorbing force of the vulcanized rubber and enhancing favorable water draining performance owing to the formed void, the content of the flat resin in the rubber composition of the present invention is preferably 0.1 parts by mass or more based on 100 parts by mass of the rubber component, and from the viewpoint of keeping durability of the vulcanized rubber, it is preferably 100 parts by mass or less. Furthermore, from the same viewpoints, the content of the flat resin is more preferably 0.1 to 50 parts by mass based on 100 parts by mass of the rubber component.

### (Complex Resin)

The flat resin is preferably a complex resin comprising a hydrophilic resin and a coat layer coating the hydrophilic resin, wherein the coat layer is composed of a resin having an affinity with the rubber component. Namely, it is preferred that the flat resin is a complex resin including a hydrophilic resin serving as a core material and a coat layer coating the hydrophilic resin as the core material, the coat layer being composed of a resin having an affinity with the rubber component.

In the case where the flat resin has such a configuration, it may be considered that the flat resin is readily dispersed in the rubber composition and attaches in a film-like form to a part or the whole of a wall face of the flat resin-originated void formed in the vulcanized rubber. Accordingly, at least a part of the wall face of the void is readily hydrophilized. As a result, it may be considered that water readily enter the void, whereby the water absorbing force owing to the capillary phenomenon becomes much larger.

As mentioned previously, the void of the vulcanized rubber is generated when the resin having a melting point lower than the vulcanization temperature of the rubber composition is used as the flat resin (short fibrous resin), and the flat resin is melted by means of vulcanization of the rubber composition, or when the vulcanized rubber is rubbed by the road surface or the like, and the flat resin peels off from the vulcanized rubber. As for the void generated when the vulcanized rubber is rubbed by the road surface or the like, and the flat resin peels off from the vulcanized rubber, in view of the fact that the wall face of the void is hardly hydrophilized, the voids of the vulcanized rubber and the tire are preferably a void generated when the complex resin in which the flat resin contains a hydrophilic resin is melted.

The hydrophilic resin and the resin having an affinity with the rubber component are hereunder described.

### [Hydrophilic Resin]

The hydrophilic resin indicates a resin having a contact angle against water of 5 to 80°.

The contact angle against water of the hydrophilic resin can be determined by preparing a test piece which is obtained by molding the hydrophilic resin in a smooth plate-like form; using an automated contact angle meter DM-301, manufactured by Kyowa Interface Science Co., Ltd.; dropping water on the surface of the test piece under a condition at 25° C. and a relative humidity of 55%; and immediately thereafter, when observed right sideways, measuring an angle formed by a straight line of the test piece surface and a tangential line of the waterdrop surface.

As the hydrophilic resin, there is exemplified a resin having a hydrophilic group in a molecule thereof. Specifically, a resin containing at least one selected from an oxygen atom, a nitrogen atom, and a sulfur atom is preferred. For example, a resin containing at least one substituent selected from the group consisting of —OH, —COOH, —OCOR (where R is an alkyl group), —NH₂, —NCO, and —SH is exemplified. Of these substituents, —OH, —COOH, —OCOR, —NH₂, and —NCO are preferred.

As mentioned above, although it is preferred that the hydrophilic resin has a small contact angle against water and has hydrophilicity with water, the hydrophilic resin is preferably insoluble in water.

In the case where the hydrophilic resin is insoluble in water, when water attaches to the vulcanized rubber surface and the tire surface, melting of the hydrophilic resin into water can be prevented from occurring, and the water absorbing force of the void originated from the flat resin can be kept.

As such a hydrophilic resin which is large in the contact angle against water, and on the other hand, is insoluble in water, more specifically, there are exemplified an ethylene-vinyl alcohol copolymer, a vinyl alcohol homopolymer, a poly(meth)acrylic acid resin or an ester resin thereof, a polyamide resin, a polyethylene glycol resin, a carboxy vinyl copolymer, a styrene-maleic acid copolymer, a polyvinylpyrrolidone resin, a vinylpyrrolidone-vinyl acetate copolymer, and mercapto ethanol.

Above all, at least one selected from the group consisting of an ethylene-vinyl alcohol copolymer, a vinyl alcohol homopolymer, a poly(meth)acrylic acid resin, a polyamide resin, an aliphatic polyamide-based resin, an aromatic polyamide-based resin, a polyester resin, a polyolefin resin, a polyvinyl alcohol-based resin, and an acrylic resin is preferred, and an ethylene-vinyl alcohol copolymer is more preferred.

[Resin Having Affinity with Rubber Component]

The resin having an affinity with the rubber component indicates a resin having a solubility parameter (SP value) close to the SP value of the rubber component to be contained in the rubber composition. The closer the mutual SP values, the higher the affinity is, and the both are readily compatibilized with each other.

As for a SP value difference, a difference between the SP value (SP1) of the rubber component and the SP value (SP2) of the resin (|SP1-SP2|) is preferably 2.0 MPa^{1/2} or less.

The SP value of each of the rubber component and the resin can be calculated according to the Fedors method.

The resin having an affinity with the rubber component is preferably a low-melting point resin having a melting point lower than a maximum vulcanization temperature of the rubber composition.

In the case where the flat resin includes such a coat layer, a favorable affinity with the rubber component in the vicinity of the complex resin can be exhibited while effectively keeping an affinity with water which the hydrophilic resin itself has.

In the case where the flat resin includes the coat layer, when the rubber composition contains a foaming agent, the hydrophilic resin which is hardly melted during vulcanization is complemented, whereby formation of the void originated from the complex resin can be promoted. That is, when the vulcanized rubber is formed by ensuring favorable dispersion of the complex resin in the rubber composition, while thoroughly exhibiting a water draining effect to be caused due to the hydrophilic resin, a function as a water draining groove owing to the void originated from the complex resin can be thoroughly exhibited.

In the case where the low-melting point resin is melted during vulcanization of the rubber composition, the coat layer born with fluidity is formed and contributes to adhesion between the rubber and the complex resin, whereby a tire imparted with favorable water draining performance and durability can be easily realized.

Although the thickness of the coat layer is variable with the content of the hydrophilic resin in the rubber composition, the average diameter of the complex resin, and so on, it is typically 0.001 to 10 μm, and preferably 0.001 to 5 μm. In the case where the coat layer has a thickness falling within the aforementioned range, a synergistic effect between the void resulting from hydrophilization of the wall face and the capillary phenomenon is readily obtained.

The coat layer of the complex resin may be formed over the entire surface of the hydrophilic resin or may be formed on a part of the surface of the hydrophilic resin. Specifically, the coat layer is preferably formed in a proportion occupying at least 50% of the entire surface area of the complex resin.

The low-melting point resin is a resin having a melting point lower than a maximum vulcanization temperature of the rubber composition, and the maximum vulcanization temperature means a maximum temperature which the rubber composition reaches during vulcanization of the rubber composition. For example, in the case of mold vulcanization, a maximum temperature which the rubber composition reaches during a time when the rubber composition enters a mold and comes out for cooling from the mold is meant. Such a maximum vulcanization temperature can be, for example, measured by embedding a thermocouple in the rubber composition, or the like.

Although an upper limit of the melting point of the low-melting point resin is not particularly limited, it is preferably selected taking into consideration the foregoing points. In general, the melting point of the low-melting point resin is preferably lower by 10° C. or more, and more preferably lower by 20° C. or more than the maximum vulcanization temperature of the rubber composition. Although an industrial vulcanization temperature of the rubber composition is generally about 190° C. at maximum, for example, in the case where the vulcanization maximum temperature is set to 190° C., the melting point of the low-melting point resin is typically selected within a range of 190° C. or lower, and it is preferably 180° C. or lower, and more preferably 170° C. or lower.

The melting point of the flat resin can be measured using a melting point measuring apparatus that is known by itself, or the like, and for example, a melting peak temperature as measured using a differential scanning calorimetry (DSC measurement) apparatus can be adopted as the melting point.

Specifically, the low-melting point resin is preferably a resin in which the amount of a polar component is 50% by mass or less relative to all of the components in the low-melting point resin, and more preferably a polyolefin-based resin. In the case where the low-melting point resin is a resin in which the amount of a polar component falls within the aforementioned range relative to all of the components, the foregoing the low-melting point resin not only has an appropriate difference in the SP value from the rubber component but also has a melting point appropriately lower than the maximum vulcanization temperature, and a favorable affinity with the rubber component can be sufficiently ensured. Furthermore, in the case where the rubber composition contains a foaming agent, the coat layer is easily melted during vulcanization, whereby foaming of the vulcanized rubber can be promoted.

In consequence, the void originated from the complex resin is readily formed while improving dispersibility of the complex resin in the rubber composition.

The aforementioned polyolefin-based resin may be either branched or linear, or the like. In addition, the polyolefin-based resin may also be an ionomer resin composed of an ethylene-methacrylic acid copolymer crosslinked intermolecularly with a metal ion. Specifically, examples thereof include polyethylene, polypropylene, polybutene, polystyrene, an ethylene-propylene copolymer, an ethylene-methacrylic acid copolymer, an ethylene-ethyl acrylate copolymer, an ethylene/propylene/diene terpolymer, an ethylene/vinyl acetate copolymer, and ionomer resins thereof. The polyolefin-based resin may also be a modified resin having been modified with maleic anhydride or the like. These may be used alone or may be used in combination of two or more thereof.

Above all, the polyolefin-based resin as the low-melting point resin preferably includes at least one selected from the group consisting of a polyethylene-based resin, a polypropylene-based resin, a polyolefin ionomer, and a maleic anhydride-modified α-polyolefin.

In order to produce the complex resin composed of the hydrophilic resin coated with a coat layer formed of a low-melting point resin, a method in which the low-melting point resin and the hydrophilic resin are blended using a mixing mill, the blend is subjected to melt spinning to form unstretched yarns, and the unstretched yarns are formed in a fibrous state while heat stretching can be adopted.

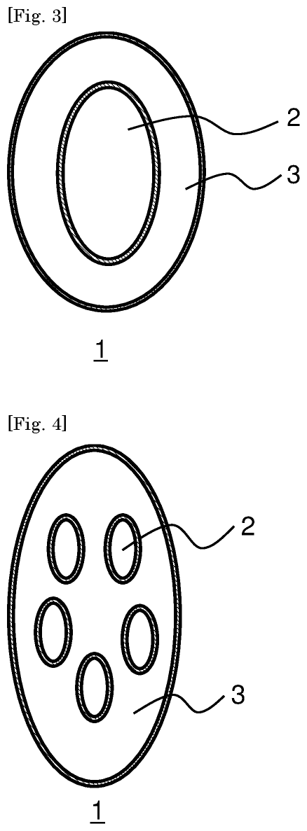

A method in which the low-melting point resin and the hydrophilic resin are blended using two twin-screw extruders provided with a die 1 as illustrated in FIG. 3 or 4, followed by forming in a fibrous state in the same manner, may also be adopted. In this case, the hydrophilic resin and the low-melting point resin are simultaneously extruded from a die outlet 2 and a die outlet 3, respectively, from which are then formed unstretched yarns.

Although the charge amount of each of the low-melting point resin and the hydrophilic resin into a mixing mill or a hopper is variable with the length of the resulting complex resin (length C in FIG. 1), the cross-sectional area, and so on, the charge amount of the low-melting point resin is 5 to 300 parts by mass, and preferably 10 to 150 parts by mass based on 100 parts by mass of the hydrophilic resin.

In the case where the low-melting point resin and the hydrophilic resin are charged in the amounts falling within the aforementioned ranges into a mixing mill or a hopper, the coat layer is readily formed on the surface of the hydrophilic resin.

### [Foaming Agent]

Preferably, the rubber composition of the present invention further contains a foaming agent.

In the case where the rubber composition contains the foaming agent, cells are generated in the vulcanized rubber owing to the foaming agent, so that the vulcanized rubber can be formed in a foamed rubber. The foamed rubber has flexibility, and therefore, the tire surface using the vulcanized rubber is easy to come into intimate contact with the icy road surface. In addition, in the case where a cell-originated void is generated by the cells on the vulcanized rubber surface and the tire surface, the void functions as a waterway for draining off water.

Furthermore, by invading a gas generated by the foaming agent into the interior of the hydrophilic resin via the coat layer composed of a molten low-melting point resin, a void having a shape linked to the shape of the complex resin, namely a longitudinal shape, can be readily formed. In the case where the void having such a shape linked to the shape of the complex resin exists in the rubber, the water absorbing force of the vulcanized rubber is improved, and the tire is excellent in the on-ice performance.

Specifically, examples of the foaming agent include azodicarbonamide (ADCA), dinitrosopentamethylenetetramine (DPT), dinitrosopentastyrenetetramine, a benzenesulfonylhydrazide derivative, p,p′-oxybisbenzenesulfonylhydrazide (OBSH), ammonium bicarbonate capable of generating carbon dioxide, sodium bicarbonate, ammonium carbonate, a nitrososulfonylazo compound capable of generating nitrogen, N,N′-dimethyl-N,N′-dinitrosophthalamide, toluenesulfonylhydrazide, p-toluenesulfonylsemicarbazide, and p,p′-oxybisbenzenesulfonylsemicarbazide. Above all, from the viewpoint of production processability, azodicarbonamide (ADCA) and dinitrosopentamethylenetetramine (DPT) are preferred. These foaming agents may be used alone or may be used in combination of two or more thereof.

Although the content of the foaming agent in the rubber composition is not particularly limited, it is preferably in a range of from 0.1 to 20 parts by mass based on 100 parts by mass of the rubber compound.

The foaming agent may be contained in the complex resin.

In the case of using a foaming agent for the purpose of foaming the vulcanized rubber, it is preferred to jointly use, as a foaming auxiliary, urea, zinc stearate, zinc benzenesulfinate, zinc oxide, or the like. These may be used alone or may be used in combination of two or more thereof. By jointly using the foaming auxiliary, the foaming reaction is promoted to increase the degree of perfection of the reaction, whereby unnecessary deterioration with time can be suppressed.

In the vulcanized rubber obtained after vulcanizing the rubber composition containing a foaming agent, the foaming ratio is typically 1 to 50%, and preferably 5 to 40%. In the case of mixing the foaming agent, when the foaming ratio is excessively large, the void of the rubber surface becomes large, so that there is a concern that a sufficient ground contact area cannot be ensured. However, so far as the foaming ratio falls within the aforementioned range, the amount of cells can be appropriately kept while ensuring formation of cells effectively functioning as the water draining groove, and therefore, durability is hardly impaired. Here, the foaming ratio of the vulcanized rubber means an average foaming ratio Vs, and specifically, it means a value calculated according to the following formula (I).

Vs=(ρ₀/ρ₁−1)×100(%) (I)

In the formula (I), ρ₁ represents a density (g/cm³) of the vulcanized rubber (foamed rubber), and ρ₀ represents a density (g/cm³) of the solid phase section in the vulcanized rubber (foamed rubber).

The foaming ratio determined according to the formula (I) is a voidage including not only voids of cells generated through foaming of the foaming agent but also voids generated when the flat resin is melted by vulcanization and voided.

In the rubber composition of the present invention, besides the foaming agent and the foaming auxiliary, if desired, compounding agents which are typically used in the rubber industry, for example, a filler, such as carbon black, a softening agent, stearic acid, an anti-aging agent, zinc oxide, a vulcanization accelerator, a vulcanizer, etc., may be appropriately selected and contained together with the flat resin (preferably the complex resin in which the hydrophilic resin is coated with the coat layer composed of the resin having an affinity with the rubber component) within a range where the purpose of the present invention is not impaired.

The vulcanized rubber obtained from the rubber composition of the present invention has a high water absorbing force, and when used for a tire, the vulcanized rubber is excellent in the spring water absorbing force on the ice. Therefore, the rubber composition of the present invention is suitable for the rubber composition for tread.

### <Vulcanized Rubber>

The vulcanized rubber of the present invention is a rubber prepared by vulcanizing the rubber composition of the present invention as mentioned previously.

In consequence, the vulcanized rubber of the present invention has the flat void that is a void originated from the short fibrous resin, having a ratio M/N of larger than 1, wherein M is a length of a cross section perpendicular to a long axis direction in a long diameter direction thereof and N is a length of the cross section perpendicular to the long axis direction in a short diameter direction thereof. In the case where the vulcanized rubber has a flat void having a ratio M/N of larger than 1, it is excellent in the water absorbing force.

Furthermore, from the viewpoint of more improving the water absorbing force, in the vulcanized rubber of the present invention, it is preferred that a proportion of the flat void is half the number or more of all voids.

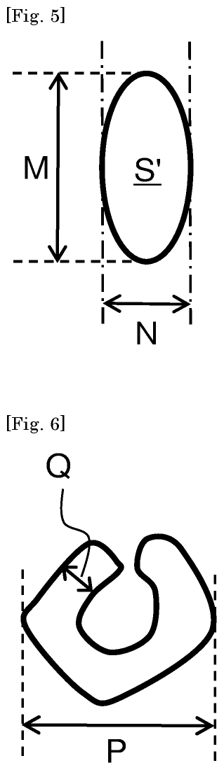

FIG. 5 is a schematic view illustrating a cross-sectional shape of the void originated from the short fibrous resin.

Here, in the FIG. 1 used for explaining the short fibrous resin, when the short fibrous resin is likened as the flat void, the length M is a length corresponding to the length A, and the length N is a length corresponding to the length B. Preferred ranges of the length M, the length N, and the ratio M/N are the same as the preferred ranges of the length A, the length B, and the ratio A/B of the short fibrous resin, respectively.

A preferred range of an area of a cross section S′ perpendicular to the long axis direction of the flat void (surface corresponding to the cross section S of the short fibrous resin in FIG. 1) is the same as the preferred range of the area of the cross section S. Although the shape of the foregoing cross section is not limited, it is preferably elliptical. A preferred range of an average length of the length in the long axis direction of the flat void (length corresponding to the length C of the short fibrous resin in FIG. 1) is the same as the preferred range of the length C.

In FIG. 5, in the case where a ratio of the length M of the long diameter of the cross section S′ to the length N of the short diameter of the cross section S′, namely M/N, is larger than 1, the cross section S′ becomes elliptical. The cross section of the void originated from the resin fiber is not limited to the elliptical void originated from the single resin fiber as illustrated in FIG. 5, and it may also be an irregular shape derived from a complex prepared by complexation of plural resin fibers. Specifically, there is exemplified a communicated void generated when two or more resin fibers are superimposed by means of kneading the rubber composition and melted. FIG. 6 is a schematic view illustrating a cross-sectional shape of an irregular void originated from a complexed short fibrous resin. As for the irregular void as illustrated in FIG. 6, when a maximum length of the void is defined as P, and a minimum length in the width of the void is defined as Q, a ratio P/Q of P to Q has only to be larger than 1.

The shape of the void which the vulcanized rubber has can be, for example, confirmed by cutting out a block-shaped sample from the vulcanized rubber, taking a photograph of a cross section of the sample with an optical microscope of 100 to 400 magnifications, and measuring the long axis and the short axis of the void. In addition, a proportion of the flat void may be, for example, calculated by likening, as a matrix, the void observed in three or more different places in a field of vision of 2 mm×3 mm by using an optical microscope.

Furthermore, in the vulcanized rubber, it is preferred that at least a part of the wall face of the void is hydrophilized. The void which the vulcanized rubber has is the void originated from the flat resin as mentioned previously, and as explained by reference to FIGS. 1 and 2, the void has the water absorbing force owing to a capillary phenomenon. Furthermore, in the case where at least a part of the wall face of the void is hydrophilized, it may be considered that the water absorbing force becomes larger.

### <Tire and Studless Tire>

The tire and the studless tire of the present invention include the vulcanized rubber of the present invention.

In consequence, each of the tire and the studless tire of the present invention has a flat void having a ratio M/N of larger than 1, wherein M is a length of a cross section perpendicular to a long axis direction in a long diameter direction thereof and N is a length of the cross section perpendicular to the long axis direction in a short diameter direction thereof. A proportion of the flat void which the tire and the studless tire each have is preferably half the number or more of all voids. In addition, it is preferred that at least a part of the wall face of the void is hydrophilized.

As mentioned previously, since the vulcanized rubber of the present invention has a large water absorbing force, even when a water film is spread on the road surface, water is taken into the tire owing to a capillary phenomenon by the cavity originated from the flat resin formed on the tire surface, whereby skidding can be prevented from occurring. In particular, the vulcanized rubber of the present invention is excellent in the spring water absorbing force on the ice. Therefore, the vulcanized rubber of the present invention is suitable for a studless tire, and the studless tire is excellent in the on-ice performance.

The tire may be obtained by using an unvulcanized rubber composition and after molding, vulcanizing it according to the kind or member of the tire to be applied. Alternatively, the tire may be obtained by performing a preliminary vulcanization process to once obtain a semi-vulcanized rubber from an unvulcanized rubber composition, molding it, and further performing the full-scale vulcanization. Among various members of the tire, from the viewpoint that favorable water draining performance and excellent fracture resistance can be sufficiently exhibited, the vulcanized rubber of the present invention is preferably applied to tread members. As a gas to be filled in the tire, besides usual air or air whose oxygen partial pressure has been regulated, an inert gas, such as nitrogen, argon, and helium, can be used.

### EXAMPLES

The present invention is hereunder described in more detail by reference to Examples, but it should be construed that these Examples are aimed to exemplify the present invention and do not limit the present invention at all.

### <Short Fibrous Resin (Short Fiber)>

1. Resin 1 Free from a Coat Layer and not Using a Hydrophilic Resin

Polyethylene (NOVATEC EIJ360 (MFR: 5.5, melting point: 132° C.), manufactured by Japan Polyethylene Corporation) was kneaded with a kneading machine, the resin was extruded from a die, and then cut in a length of 3 mm, thereby producing Resin 1 formed of polyethylene.

A ratio A/B of the length A of the cross section to the length B of the cross section of Resin 1 was 1.8. In addition, an average length of the length A was 0.05 mm; an average area of the cross section (cross section S in FIG. 1) was 0.001 mm²; and an average length of the length in the long axis direction (length C in FIG. 1) was 3 mm.

The length A of the cross section, the length B of the cross section, and the length C in the long axis direction of Resin 1 are each a value obtained by photographing Resin 1 with an optical microscope of 20 to 400 magnifications, measuring the length of each of 100 samples, and calculating an arithmetic average value thereof. An aspect ratio (length A/length B) of Resin 1 was calculated from the obtained numerical values. The same is also applicable to Resins 2 to 5 and 101 as mentioned later. The results are shown in Table 2.

### 2. Resin 2 Having a Coat Layer Having a Hydrophilic Resin as a Core Material Coated Thereon (Complex Resin)

Two twin-screw extruders were used, and 40 parts by mass of polyethylene (NOVATEC EIJ360 (MFR: 5.5, melting point: 132° C.), manufactured by Japan Polyethylene Corporation) and 40 parts by mass of an ethylene-vinyl alcohol copolymer (EVAL F104B (MFR: 4.4, melting point: 183° C.), manufactured by Kuraray Co., Ltd.) were charged in a hopper. The ethylene-vinyl alcohol copolymer and the polyethylene were simultaneously extruded from the die outlet 2 and the die outlet 3, respectively in the configuration illustrated in FIG. 3, and the obtained complex resin was cut in a length of 3 mm according to a conventional method, thereby producing Resin 2 that is a complex resin in which a coat layer formed of polyethylene was formed.

A ratio A/B of the length A of the cross section to the length B of the cross section of Resin 2 was 1.8. In addition, an average length of the length A was 0.05 mm; an average area of the cross section (cross section S in FIG. 1) was 0.001 mm²; and an average length of the length in the long axis direction (length C in FIG. 1) was 3 mm.

### 3. Resins 3 to 5 Each Having a Coat Layer Having a Hydrophilic Resin as a Core Material Coated Thereon (Complex Resins)

Resins 3 to 5 that are each a complex resin were produced in the same manner as in the production of Resin 2 that is a complex resin, except that the long diameter/short diameter of the die outlet 2 and the long diameter/short diameter of the die outlet 3 in the configuration illustrated in FIG. 3 were changed.

A ratio A/B of the length A of the cross section to the length B of the cross section of the resulting Resin 3 was 2.4. In addition, an average length of the length A was 0.05 mm; an average area of the cross section (cross section S in FIG. 1) was 0.0008 mm²; and an average length of the length in the long axis direction (length C in FIG. 1) was 3 mm.

A ratio A/B of the length A of the cross section to the length B of the cross section of the resulting Resin 4 was 2.7. In addition, an average length of the length A was 0.05 mm; an average area of the cross section (cross section S in FIG. 1) was 0.0007 mm²; and an average length of the length in the long axis direction (length C in FIG. 1) was 3 mm.

A ratio A/B of the length A of the cross section to the length B of the cross section of the resulting Resin 5 was 4.6. In addition, an average length of the length A was 0.05 mm; an average area of the cross section (cross section S in FIG. 1) was 0.0004 mm²; and an average length of the length in the long axis direction (length C in FIG. 1) was 3 mm.

4. Resin 101 Free from a Coat Layer and not Using a Hydrophilic Resin

Resin 101 was produced in the same manner as in the production of Resin 1, except that the long diameter/short diameter of the die outlet 2 and the long diameter/short diameter of the die outlet 3 in the configuration illustrated in FIG. 3 were changed.

A ratio A/B of the length A of the cross section to the length B of the cross section of Resin 101 was 1.0. In addition, an average length of the length A was 0.05 mm; an average area of the cross section was 0.002 mm²; and an average length of the length in the long axis direction was 3 mm.

### <Preparation of Rubber Composition and Production of Vulcanized Rubber>

### [Preparation of Rubber Composition]

Each of Resin 101 and Resins 1 to 5 is used, and the respective components are mixed and kneaded according to the blend shown in Table 1, thereby obtaining rubber compositions of Comparative Example 1 and Examples 1 to 5.

### [Production of Vulcanized Rubber]

Each of the obtained rubber compositions of the Examples and Comparative Example is vulcanized at a maximum vulcanization temperature of 190° C., thereby obtaining a vulcanized rubber.

### <Evaluation>

### (1) Foaming Ratio Index

A density ρ₁ (g/m³) of a block-shaped sample the same as that when measuring the average foaming diameter is measured, whereas a density ρ₀ of a non-foamed rubber (solid phase rubber) is measured, thereby determining a foaming ratio according to the following formula.

Foaming ratio V=(ρ₀/ρ₁−1)×100(%)

The foaming ratio is expressed in terms of an index while defining the foaming ratio of Comparative Example 1 as 100.

### (2) Water Absorbing Performance Index

On the ice surface, a vulcanized rubber obtained by further cutting out the obtained vulcanized rubber using a slicer is pressed at 150 N for 30 seconds, and the amount of water absorption is calculated from a difference in mass of the vulcanized rubber before and after the processing. The amount of water absorption is expressed in terms of an index while defining the amount of water absorption of Comparative Example 1 as 100.

### (3) On-Ice Performance Index

A vehicle fitted with new test tires produced from the rubber composition of each of the Examples and Comparative Example is traveled on the flat road on ice, and at the point of time when the speed per hour reached 20 km/h, braking is applied to lock the tires, thereby measuring a braking distance until the vehicle reached a stopped state.

The on-ice performance index was expressed in terms of an index while defining a reciprocal of the braking distance of Comparative Example 1 as 100.0. It is indicated that the larger the index value, the more excellent the braking performance on the ice is.

TABLE 1

| | |
|---|---|
| Natural rubber | 60 |
| Polybutadiene rubber | 40 |
| Carbon black | 60 |
| Stearic acid | 2 |
| Zinc oxide | 6 |
| Vulcanization accelerator | 1.2 |
| Insoluble sulfur | 4 |
| Foaming agent | 4 |
| Resin (short fiber) | 5 |

(parts by mass)

Details of the components in Table 1 are as follows.

Polybutadiene rubber: “BR01”, cis-1,4-polybutadiene, manufacture by JSR Corporation

Carbon black: “CARBON N220”, manufactured by Asahi Carbon Co.,

Ltd.

Vulcanization accelerator: “NOCCELER DM”, di-2-benzothiazyl disulfide, manufactured by Ouchi Shinko Chemical Industrial Co., Ltd.

Foaming agent: “CELLMIC AN”, dinitrosopentamethylenetetramine (DPT), manufactured by Sankyo Kasei Co., Ltd.

TABLE 2

| | | Comparative | | | | | |
|---|---|---|---|---|---|---|---|
| | | Example 1 | Example 1 | Example 2 | Example 3 | Example 4 | Example 5 |
| Resin | Aspect ratio, A/B | 1.0 | 1.8 | 1.8 | 2.4 | 2.7 | 4.6 |
| (short fiber) | Hydrophilic resin | No | No | Yes | Yes | Yes | Yes |
| | Kind of resin | Resin 101 | Resin 1 | Resin 2 | Resin 3 | Resin 4 | Resin 5 |
| Evaluation | Foaming ratio index | 100 | 99 | 99 | 101 | 100 | 100 |
| | Water absorbing | 100 | 109 | 121 | 132 | 138 | 132 |
| | performance index | | | | | | |
| | On-ice | 100.0 | 101.0 | 107.8 | 111.3 | 114.5 | 112.6 |
| | performance index | | | | | | |

As is noted from Table 2, all of the vulcanized rubbers of the Examples produced using, as a short fibrous resin, a flat resin having an aspect ratio (length A/length B) of larger than 1 were larger in the water absorbing force than the vulcanized rubber of the comparative example produced using, as a short fibrous resin, a short fibrous resin having an aspect ratio (A/B) of 1.0, and the tires of the Examples were excellent in the on-ice performance.

A block-shaped sample was cut out from the tread rubber of the test tire produced in the evaluation of on-ice performance index, a photograph of a cross section of the sample was taken with an optical microscope of 100 to 400 magnifications, and the long axes and the short axes of 200 or more voids were measured. As a result, the majority in all of the observed voids was a flat void having a ratio M/N of larger than 1.

In addition, it is noted that the vulcanized rubbers of Examples 2 to 5 produced by using the short fibrous resin that is a complex resin using a hydrophilic resin and coated with a low-melting point resin, the short fibrous resin having an aspect ratio (A/B) of more than 1, have more excellent water absorbing force and on-ice performance than those of the vulcanized rubber of Example 1, owing to a synergistic effect between the aspect ratio of the cross section of the flat shape and the wall face of the hydrophilized void.

### REFERENCE SIGNS LIST

a: Long axis direction on the cross section perpendicular to the long axis direction of the short fibrous resin
b: Long axis direction of the short fibrous resin
S: Cross section perpendicular to the long axis direction of the short fibrous resin
A: Length of the cross section of the long diameter direction in the cross section perpendicular to the long axis direction of the short fibrous resin
B: Length of the cross section of the short diameter direction perpendicular to the long diameter direction in the cross section perpendicular to the long axis direction
C: Length of the long axis direction of the short fibrous resin
D1: Short fibrous resin in the present invention
D2: Short fibrous resin in the present invention
D3: Conventional short fibrous resin
d1: Cross-sectional shape of the void originated from the short fibrous resin D1
d2: Cross-sectional shape of the void originated from the short fibrous resin D2
d3: Cross-sectional shape of the void originated from the short fibrous resin D3
e1: Long axis direction of the short fibrous resins D1, D2, and D3
e2: Cut surface of the vulcanized rubber
M: Length of the cross section of the long diameter direction in the cross section perpendicular to the long axis direction in the void originated from the short fibrous resin
N: Length of the cross section of the short diameter direction perpendicular to the long diameter direction in the void originated from the short fibrous resin
S′: Cross section perpendicular to the long axis direction of the flat void in the void originated from the short fibrous resin
P: Maximum length of the irregular void originated from the complexed short fibrous resin
Q: Minimum length in the width of the irregular void originated from the complexed short fibrous resin
1: Die of twin-screw extruder
2: Die outlet for hydrophilic resin
3: Die outlet for resin having an affinity with the rubber component

1. A rubber composition comprising
a rubber component and
a short fibrous resin having a ratio A/B of larger than 1, wherein A is a length of a cross section perpendicular to a long axis direction in a long diameter direction thereof and B is a length of the cross section perpendicular to the long axis direction in a short diameter direction thereof.

2. The rubber composition according to claim 1, further comprising a foaming agent.

3. The rubber composition according to claim 1, wherein the short fibrous resin is a complex resin comprising a hydrophilic resin and a coat layer coating the hydrophilic resin, wherein the coat layer is composed of a resin having an affinity with the rubber component.

4. The rubber composition according to claim 3, wherein the hydrophilic resin contains at least one selected from an oxygen atom, a nitrogen atom, and a sulfur atom.

5. The rubber composition according to claim 3, wherein the resin having an affinity with the rubber component is a low-melting point resin having a melting point lower than a maximum vulcanization temperature of the rubber composition.

6. The rubber composition according to claim 1, wherein the ratio A/B of the short fibrous resin is 10 or less.

7. The rubber composition according to claim 1, wherein an average length of the short fibrous resin in a longitudinal direction is from 0.1 to 500 mm.

8. The rubber composition according to claim 1, wherein the content of the short fibrous resin is from 0.1 to 100 parts by mass based on 100 parts by mass of the rubber component.

9. The rubber composition according to claim 1, wherein an average area of the cross section of the short fibrous resin is from 0.000001 to 0.5 mm².

10. The rubber composition according to claim 3, wherein the hydrophilic resin contains at least one substituent selected from the group consisting of —OH, —COOH, —OCOR (where R is an alkyl group), —NH₂, —NCO, and —SH.

11. The rubber composition according to claim 3, wherein the hydrophilic resin contains at least one selected from the group consisting of an ethylene-vinyl alcohol copolymer, a vinyl alcohol homopolymer, a poly(meth)acrylic acid resin, a polyamide resin, an aliphatic polyamide-based resin, an aromatic polyamide-based resin, a polyester resin, a polyolefin resin, a polyvinyl alcohol-based resin, and an acrylic resin.

12. The rubber composition according to claim 5, wherein the low-melting point resin is a polyolefin-based resin.

13. The rubber composition according to claim 12, wherein the polyolefin-based resin contains at least one selected from the group consisting of a polyethylene-based resin, a polypropylene-based resin, a polyolefin ionomer, and a maleic anhydride-modified α-polyolefin.

14. The rubber composition according to claim 1, which is a rubber composition for tread.

15. A vulcanized rubber obtained by vulcanizing the rubber composition according to claim 1.

16. The vulcanized rubber according to claim 15, having a flat void having a ratio M/N of larger than 1, wherein M is a length of a cross section perpendicular to a long axis direction in a long diameter direction thereof and N is a length of the cross section perpendicular to the long axis direction in a short diameter direction thereof, with a proportion of the flat void being half the number or more of all voids.

17. The vulcanized rubber according to claim 15, wherein at least a part of a wall face of the void is hydrophilized.

18. A tire comprising the vulcanized rubber according to claim 15.

19. A studless tire comprising the vulcanized rubber according to claim 15.
